(19) United States
(12) Patent Application Publication
(10) Pub. No.: US 2022/0221479 A1
(43) Pub. Date: Jul. 14, 2022

(54) PIERCING CONDITION SELECTION METHOD

(71) Applicants: SEKISUI MEDICAL CO., LTD., Tokyo (JP); CANON MEDICAL SYSTEMS CORPORATION, Tochigi (JP)

(72) Inventors: Toshiki KAWABE, Tokyo (JP); Kosuke OGASAWARA, Tokyo (JP); Yumi IIJIMA, Tokyo (JP); Masaaki IWASAKI, Tochigi (JP)

(21) Appl. No.: 17/707,962

(22) Filed: Mar. 30, 2022

Related U.S. Application Data
(63) Continuation of application No. PCT/JP2020/035943, filed on Sep. 24, 2020.

(30) Foreign Application Priority Data
Sep. 30, 2019 (JP) 2019-180786

(51) Int. Cl. G01N 35/10; G01N 35/02; G01N 35/00

(52) U.S. Cl. CPC G01N 35/1079; G01N 35/00732; G01N 35/02

(57) ABSTRACT

An automatic analysis apparatus includes a rack identification information reading unit for reading rack identification information assigned to a specimen rack, a CTS drive unit for executing a piercing operation of piercing the stopper of the specimen vessel having the stopper at a specimen suction position by a piercer and sucking a specimen in the specimen vessel having the stopper by a specimen suction nozzle passing through a hole of the stopper formed by the piercer, a piercing condition setting unit for setting a piercing operation condition by the piercer for the specimen vessel having the stopper loaded in the specimen rack based on the rack identification information read by the rack identification information reading unit, and a control unit for controlling an operation of the CTS drive unit based on a set piercing operation condition.

### RELATED APPLICATIONS

The present application is a continuation of International Application No. PCT/JP2020/035943, filed Sep. 24, 2020, which claims priority from Japanese Patent Application No. 2019-180786, filed Sep. 30, 2019, the disclosures of which applications are hereby incorporated by reference here in their entirety.

### TECHNICAL FIELD

The present invention relates to an automatic analysis apparatus capable of obtaining measurement information on various test items by causing a reaction between a sample (specimen) such as blood or urine and various reagents to measure a reaction process thereof, and a piercing condition selection method therefor.

### BACKGROUND ART

Conventionally, there have been various types of known automatic analysis apparatuses that can obtain measurement information on various test items by causing a reaction between various reagents and biological samples such as blood and urine to measure a reaction process thereof, such as a blood coagulation analysis apparatus and an analysis apparatus using an immunoassay method. For example, a specimen as a biological sample is dispensed from a specimen vessel (blood sample tube) to a reaction vessel, and a reagent according to a test item is dispensed and mixed with the dispensed specimen to perform various measurements and analyzes.

In such an analysis apparatus, when a specimen is sucked from a specimen vessel having a stopper (cap), CTS (Closed Tube Sampling: specimen dispensation from the specimen vessel having the stopper), which samples a specimen with the stopper attached, may be adopted. In this CTS, for example, a needle-shaped piercer having a hollow tube inside is used, and after the stopper is punctured by this piercer (stopper is pierced), a nozzle (specimen probe) is inserted into the specimen vessel through the inside of the piercer to suck the specimen (for example, see Patent Document 1).

In addition, in an automatic analysis apparatus adopting such a CTS method, despite the existence of stoppers of various materials and specimen vessels of various shapes, at present, the number of operation conditions of a piercing operation of puncturing a stopper of a specimen vessel by a piercer is fixed to one (for example, see Patent Document 2).

### CITATION LIST

### Patent Document

Patent Document 1: JP 2015-155925 A
Patent Document 2: WO/2016/084462

### SUMMARY OF THE INVENTION

### Problem to be Solved by the Invention

However, considering that an influence of puncturing (piercing) on the specimen vessel differs depending on the shape of the specimen vessel and the material of the stopper, when the piercing operation condition is uniform, the specimen vessel may be damaged in some cases. In addition, since most of the stoppers of the specimen vessels to be pierced are made of rubber, depending on the piercing conditions (piercing operation conditions) such as a piercing speed, a piercing force, a piercer withdrawal speed after piercing, and a piercing distance of the piercer with respect to the specimen vessel, the rubber stopper may be pushed into the specimen vessel and cannot be pierced, rubber fragments may adhere to the inside of the piercer when the piercer is hollow, or an inner hole of the piercer may be blocked with the rubber stopper.

The invention has been made by paying attention to the above-mentioned problems, and an object of the invention to provide an automatic analysis apparatus capable of realizing a piercing operation under an appropriate piercing condition according to a type of a specimen vessel having a stopper, and a piercing condition selection method therefor.

### Means for Solving Problem

To achieve the object, the invention is an automatic analysis apparatus for obtaining measurement information on a predetermined test item by causing a reaction between a specimen and a reagent to measure a reaction process thereof, including a specimen supply portion, a specimen rack loaded with the same type of one or more specimen vessels having stoppers being arranged in the specimen supply portion, a rack identification information reading unit for reading rack identification information assigned to the specimen rack, a drive unit for executing a piercing operation of piercing the stopper of the specimen vessel having the stopper at a specimen suction position by a piercer and sucking a specimen in the specimen vessel having the stopper by a specimen suction nozzle passing through a hole formed by the piercer, a piercing condition setting unit for setting a piercing operation condition by the piercer for the specimen vessel having the stopper loaded in the specimen rack based on the rack identification information read by the rack identification information reading unit, and a controller for controlling an operation of the drive unit based on a piercing operation condition set by the piercing condition setting unit.

In addition, the invention is a piercing condition selection method for an automatic analysis apparatus including a specimen supply portion, a specimen rack loaded with the same type of one or more specimen vessels having stoppers being arranged in the specimen supply portion, and a drive unit for executing a piercing operation of piercing the stopper of the specimen vessel having the stopper at a specimen suction position by a piercer and sucking a specimen in the specimen vessel having the stopper by a specimen suction nozzle passing through a hole formed by the piercer, and obtaining measurement information on a predetermined test item by causing a reaction between a reagent and the specimen sucked by the specimen suction nozzle to measure a reaction process thereof, the method including a rack identification information reading step of reading rack identification information assigned to the specimen rack, a piercing condition setting step of setting a piercing operation condition by the piercer for the specimen vessel having the stopper loaded in the specimen rack based on rack identification information read in the rack identification information reading step, and an operation control step of controlling an operation of the drive unit based on a piercing operation condition set in the piercing condition setting step.

According to the automatic analysis apparatus and the piercing condition selection method therefor having the above configuration, since the piercing operation condition by the piercer for the specimen vessel having the stopper is set based on the rack identification information assigned to the specimen rack loaded with the same type of one or more specimen vessels having stoppers, it is possible to realize the piercing operation under an appropriate (optimal) piercing condition according to the type of the specimen vessel having the stopper. For this reason, it is possible to reduce the above-mentioned piercing problems in the past, prevent a long analysis time, and reduce the amount of specimen loss. Allowing setting of the piercing condition in such specimen rack units is particularly beneficial for a micro blood collection tube (which is a dedicated tube and aligns the height on the rack) to which identification information such as a specimen ID label cannot be affixed. That is, when the micro blood collection tube is used without using an adapter, etc., the optimum piercing condition can be set even if the specimen ID is not provided, as long as the information unique to the rack is added.

### Effect of the Invention

According to the invention, there is provided an automatic analysis apparatus capable of realizing a piercing operation (CTS operation) under an appropriate piercing condition according to a type of a specimen vessel having a stopper, and a piercing condition selection method therefor.

### BRIEF DESCRIPTION OF DRAWINGS

FIG. 1 is a schematic overall external view of an automatic analysis apparatus according to an embodiment of the invention;

FIG. 2 is a block diagram illustrating a schematic configuration of the automatic analysis apparatus of FIG. 1;

FIG. 3 is a block diagram illustrating a configuration for setting an appropriate piercing operation condition for each specimen rack;

FIG. 4 is a flowchart illustrating a flow of a method for setting an appropriate piercing operation condition for each specimen rack; and

FIG. 5 is a schematic view illustrating an example of a piercing operation when a piercer is hollow.

### MODE(S) FOR CARRYING OUT THE INVENTION

Hereinafter, an embodiment of the invention will be described with reference to the drawings.

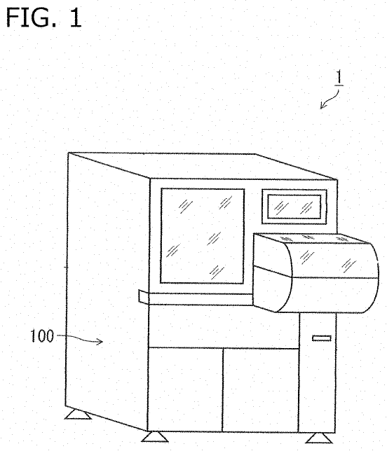

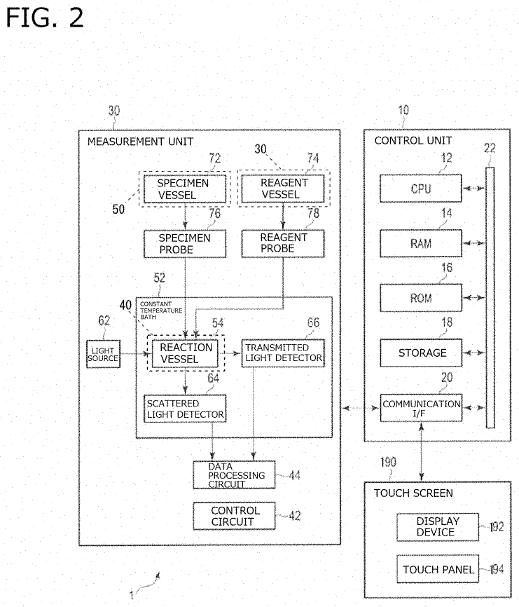

FIG. 1 is a schematic overall external view of an automatic analysis apparatus according to the present embodiment, and FIG. 2 is a block diagram illustrating a schematic configuration of the automatic analysis apparatus of FIG. 1. As illustrated in FIG. 2, the automatic analysis apparatus 1 of the present embodiment includes a specimen supply portion 50 for supplying a specimen, a reaction portion 40 for holding a reaction vessel 54 into which a specimen is dispensed, and a reagent supply portion 30 for supplying a reagent to the reaction vessel 54, and obtains measurement information on a predetermined test item by causing a reaction between a specimen and a reagent supplied from the reagent supply portion 30 to the reaction vessel 54 to measure a reaction process.

Specifically, an outer frame of the automatic analysis apparatus 1 of the present embodiment is formed by a housing 100, and the automatic analysis apparatus 1 is configured by forming a specimen processing space in an upper part of the housing 100 (see FIG. 1).

As clearly illustrated in FIG. 2, the automatic analysis apparatus 1 includes a control unit (controller) 10, a measurement unit 30, and a touch screen 190.

The control unit 10 controls the overall operation of the automatic analysis apparatus 1. The control unit 10 includes, for example, a personal computer (PC). The control unit 10 includes a Central Processing Unit (CPU) 12, a Random Access Memory (RAM) 14, a Read Only Memory (ROM) 16, a storage 18, and a communication interface (I/F) 20 connected to each other via a bus line 22. The CPU 12 performs various signal processing, etc. The RAM 14 functions as a main storage device of the CPU 12. As the RAM 14, for example, a Dynamic RAM (DRAM), a Static RAM (SRAM), etc. can be used. The ROM 16 records various boot programs, etc. For the storage 18, for example, a Hard Disk Drive (HDD), a Solid State Drive (SSD), etc. can be used. Various types of information such as programs and parameters used by the CPU 12 are recorded in the storage 18. Further, data acquired by the measurement unit 30 is recorded in the storage 18. The RAM 14 and the storage 18 are not limited thereto, and can be replaced with various storage devices. The control unit 10 communicates with an external device, for example, the measurement unit 30 and the touch screen 190 via the communication I/F 20.

The touch screen 190 includes a display device 192 and a touch panel 194. The display device 192 may include, for example, a liquid crystal display (LCD), an organic EL display, etc. The display device 192 displays various screens under the control of the control unit 10. This screen may include various screens such as an operation screen of the automatic analysis apparatus 1, a screen showing a measurement result, and a screen showing an analysis result. The touch panel 194 is provided on the display device 192. The touch panel 194 acquires an input from a user and transmits the obtained input information to the control unit 10.

The control unit 10 may be connected to other devices such as a printer, a handy code reader, and a host computer via the communication I/F 20.

The measurement unit 30 includes a control circuit 42, a data processing circuit 44, a constant temperature bath 52, the reaction vessel 54, a light source 62, a scattered light detector 64, a transmitted light detector 66, a specimen vessel (blood sample tube) 72, a reagent vessel 74, a specimen probe 76, and a reagent probe 78. In this case, the reaction vessel 54, the scattered light detector 64, and the transmitted light detector 66 are provided in the constant temperature bath 52. In addition, the specimen vessel 72 is a specimen vessel having a stopper, and a specimen rack loaded with the same type of one or more specimen vessels 72 having stoppers is arranged in the specimen supply portion 50.

The control circuit 42 controls an operation of each part of the measurement unit 30 based on a command from the control unit 10. Although not illustrated, the control circuit 42 is connected to the data processing circuit 44, the constant temperature bath 52, the light source 62, the scattered light detector 64, the transmitted light detector 66, the specimen probe 76, the reagent probe 78, etc., and controls an operation of each part.

The data processing circuit 44 is connected to the scattered light detector 64 and the transmitted light detector 66, and acquires a detection result from the scattered light detector 64 and the transmitted light detector 66. The data processing circuit 44 performs various processes on the acquired detection result and outputs a processing result. The processes performed by the data processing circuit 44 may include, for example, an A/D conversion process for converting a format of data output from the scattered light detector 64 and the transmitted light detector 66 into a format that can be processed by the control unit 10.

The control circuit 42 and the data processing circuit 44 may include, for example, a CPU, an Application Specific Integrated Circuit (ASIC), a Field Programmable Gate Array (FPGA), etc. Each of the control circuit 42 and the data processing circuit 44 may be configured by one integrated circuit, etc., or may be configured by combining a plurality of integrated circuits, etc. Further, the control circuit 42 and the data processing circuit 44 may include one integrated circuit, etc. The operation of the control circuit 42 and the data processing circuit 44 may be performed according to, for example, a program recorded in a storage device or a recording area in the circuit.

The specimen vessel 72 contains, for example, a specimen obtained from blood collected from a patient. The reagent vessel 74 contains various reagents used for measurement. Any number of specimen vessels 72 and reagent vessels 74 may be provided. Since there is usually a plurality of types of reagents used for analysis, there is generally a plurality of reagent vessels 74. The specimen probe 76 dispenses the specimen contained in the specimen vessel 72 into the reaction vessel 54 under the control of the control circuit 42. The reagent probe 78 dispenses the reagent contained in the reagent vessel 74 into the reaction vessel 54 under the control of the control circuit 42. Any number of specimen probes 76 and reagent probes 78 may be used.

The constant temperature bath 52 maintains the temperature of the reaction vessel 54 at a predetermined temperature under the control of the control circuit 42. In the reaction vessel 54, a mixed solution obtained by mixing the specimen dispensed by the specimen probe 76 and the reagent dispensed by the reagent probe 78 reacts. Note that any number of reaction vessels 54 may be used.

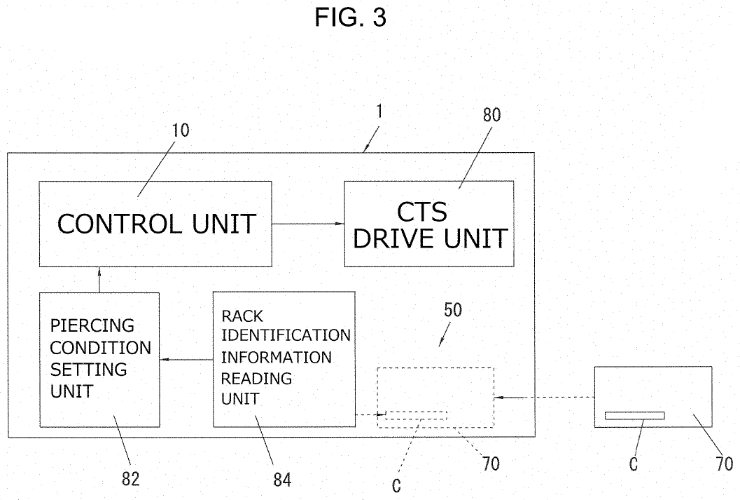

The light source 62 emits light having a predetermined wavelength under the control of the control circuit 42. The light source 62 may be configured to emit light having a different wavelength depending on the measurement condition. Therefore, the light source 62 may have a plurality of light source elements. The light emitted from the light source 62 is guided by, for example, an optical fiber, and is applied to the reaction vessel 54. The light applied to the reaction vessel 54 is partially scattered and partially transmitted depending on the reaction process state of the mixed solution in the reaction vessel 54. The scattered light detector 64 detects the light scattered in the reaction vessel 54, and detects, for example, the amount of the scattered light. The transmitted light detector 66 detects the light transmitted through the reaction vessel 54, and detects, for example, the amount of transmitted light. The data processing circuit 44 processes information on the amount of scattered light detected by the scattered light detector 64, and processes information on the amount of transmitted light detected by the transmitted light detector 66. Any one of the scattered light detector 64 and the transmitted light detector 66 may operate depending on the measurement condition. Therefore, the data processing circuit 44 may process any one of the information on the amount of scattered light detected by the scattered light detector 64 or the information on the amount of transmitted light detected by the transmitted light detector 66 according to the measurement condition. The data processing circuit 44 transmits processed data to the control unit 10. Note that even though the measurement unit 30 illustrated in FIG. 3 includes two light detectors, the scattered light detector 64 and the transmitted light detector 66, the measurement unit 30 may include any one of the light detectors.

The control unit 10 performs various calculations based on the data acquired from the measurement unit 30. These calculations include calculation of the reaction amount of the mixed solution, quantitative calculation of the substance amount or an activity value of a substance to be measured in a subject based on the reaction amount, etc. The data processing circuit 44 may perform some or all of these calculations.

Note that here, even though the case where a PC that controls the operation of the measurement unit 30 and a PC that performs data calculation and quantitative calculation are the same control unit 10 is illustrated, the PCs may be separate bodies. In other words, the PC that performs the data calculation and the quantitative calculation may exist as each.

Next, a description will be given of characteristic functional units of the automatic analysis apparatus 1 having the above configuration allowing setting of an appropriate piercing operation condition for each specimen rack, and a piercing condition selection method with reference to FIGS. 3 to 5.

As illustrated in FIG. 3, the automatic analysis apparatus 1 of the present embodiment includes a rack identification information reading unit 84 that reads rack identification information C assigned to a specimen rack 70 loaded with the same type of one or more specimen vessels 72 having stoppers, a CTS drive unit 80 that executes a piercing operation of piercing the stopper of the specimen vessel 72 having the stopper by a piercer at a specimen suction position and sucks a specimen in the specimen vessel 72 having the stopper by a specimen suction nozzle included in the specimen probe 76 passing through a hole formed by the piercer, a piercing condition setting unit 82 that sets a piercing operation condition by the piercer for the specimen vessel 72 having the stopper loaded in the specimen rack 70 based on the rack identification information C read by the rack identification information reading unit 84, and the control unit 10 that controls an operation of the CTS drive unit 80 based on the piercing operation condition set by the piercing condition setting unit 82. The automatic analysis apparatus 1 can use a plurality of specimen racks 70, and can identify the type of the specimen vessel 72 mounted on the specimen rack 70 by identifying the rack identification information C. Note that the rack identification information C assigned to the specimen rack 70 may be a coded display (bar code or a 2D code, for example, a rack ID label or a rack number) printed on or affixed to the specimen rack 70, or may be formed by a shape peculiar to the specimen rack 70 (for example, a notch or a hole for ID is included in a bit) and/or a physical element used for reading the shape. As a physical element used for reading the shape, a magnet, etc. can be mentioned. In particular, when a large amount of information can be assigned to the 2D code, etc., it is possible to set a piercing operation condition for each position on the specimen rack 70.

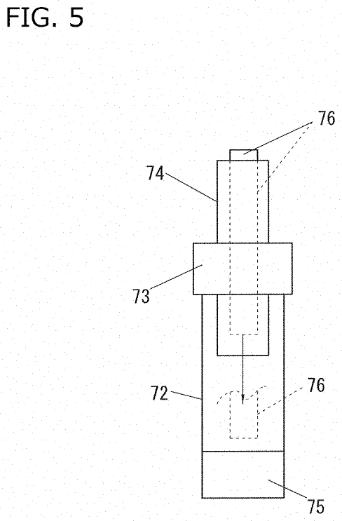

Here, FIG. 5 illustrates an example of a piercing operation using a tubular (hollow) piercer. As illustrated in the figure, a needle-shaped piercer 74, which is a hollow tube inside, is used, and after the stopper 73 closing an opening of the specimen vessel 72 is punctured (the stopper is pierced) by the piercer 74, the specimen suction nozzle (specimen probe) 76 is inserted into the specimen vessel 72 through the inside of the piercer 74 to suck a specimen 75. Note that the piercer does not have to be tubular in this way. When the piercer is not tubular, after the stopper is pierced by the piercer, the specimen suction nozzle sucks the specimen in the specimen vessel having the stopper through the hole of the stopper formed by the piercer without intervention of the piercer.

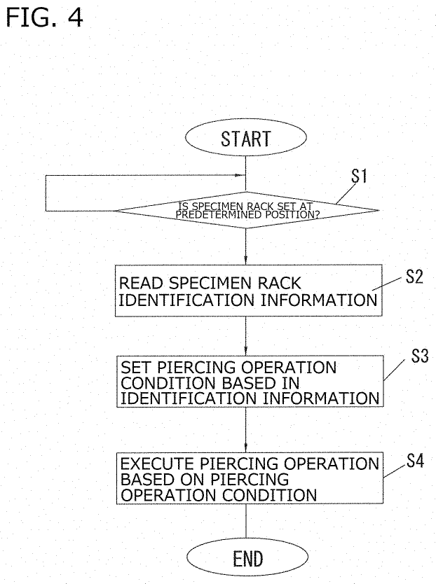

Next, a description will be given of a method of setting an appropriate piercing operation condition for each specimen rack 70 using the functional units illustrated in FIG. 3 described above with reference to FIG. 4.

First, in a state where the specimen rack 70 is set in the specimen supply portion 50 (step S1; also see FIG. 3), the rack identification information reading unit 84 reads the rack identification information C assigned to the specimen rack 70 (rack identification information reading step S2). Thereafter, the piercing condition setting unit 82 sets a piercing operation condition by the piercer for the specimen vessel 72 having the stopper loaded in the specimen rack 70 based on the rack identification information C read by the rack identification information reading unit 84 (piercing condition setting step S3). In this case, the piercing condition setting unit 82 sets the piercing operation condition (in rack units) based on an operation condition table in which the rack identification information C and the piercing operation condition are associated with each other and stored.

Note that examples of the piercing operation condition may include a lower limit of descent, a descent speed, a piercing force of the piercer, a descent speed pattern of the piercer during descent (two-step descent, etc.), inner and outer diameters of piercers (in the case of having a plurality of piercers), an upper limit point of the detection area for detecting the liquid level of the specimen with insertion of the suction nozzle (specimen probe) into the specimen vessel 72 having the stopper, the cumulative number of times of piercing, etc. Here, the cumulative number of times of piercing is useful when the stopper is damaged by a plurality of number of times of piercing by the piercer due to a characteristic of the stopper, and by cumulatively counting the number of times of piercing for each specimen ID, for example, a counting result may be fed back to the piercing condition setting unit 82 or the control unit 10.

Thereafter, when the specimen vessel 72 having the stopper is positioned at the specimen suction position, the control unit 10 controls an operation of the CTS drive unit 80 based on the piercing operation condition set by the piercing condition setting unit 82 (operation control step S4). In this way, at the specimen suction position, the stopper of the specimen vessel 72 having the stopper can be pierced by the piercer under an appropriate piercing operation condition according to the type of the specimen vessel 72 having the stopper, and then the specimen in the specimen vessel 72 having the stopper can be sucked by the specimen probe 76 passing through the hole formed by the piercer.

As described above, according to the present embodiment, since the piercing operation condition by the piercer for the specimen vessel 72 having the stopper can be set based on the rack identification information C assigned to the specimen rack 70 loaded with the same type of one or more specimen vessels 72 having stoppers, it is possible to realize the piercing operation under an appropriate (optimal) piercing condition according to the type of the specimen vessel 72 having the stopper. For this reason, it is possible to reduce the above-mentioned problems during piercing occurring in the past, prevent a long analysis time, and reduce the amount of specimen loss. In addition, allowing setting of the piercing condition in such specimen rack units is particularly beneficial for a micro blood collection tube (which is a dedicated tube and aligns the height on the rack) to which identification information such as a specimen ID label cannot be affixed. That is, when the micro blood collection tube is used without using an adapter, etc., the optimum piercing condition can be set even if the specimen ID is not provided, as long as the rack identification information C unique to the specimen rack 70 is added.

Note that the invention is not limited to the above-described embodiment, and can be variously modified and implemented without departing from the gist thereof. For example, in the invention, the form of the rack identification information, the configuration form of the automatic analysis apparatus, etc. can be arbitrarily set. In addition, some or all of the above-described embodiments may be combined, or a part of a configuration may be omitted from one of the above-mentioned embodiments.

What is claimed is:

1. An automatic analysis apparatus for obtaining measurement information on a predetermined test item by causing a reaction between a specimen and a reagent to measure a reaction process thereof, the apparatus comprising:
a specimen supply portion, a specimen rack loaded with the same type of one or more specimen vessels having stoppers being arranged in the specimen supply portion;
a rack identification information reading unit for reading rack identification information assigned to the specimen rack;
a drive unit for executing a piercing operation of piercing the stopper of the specimen vessel having the stopper at a specimen suction position by a piercer and sucking a specimen in the specimen vessel having the stopper by a specimen suction nozzle passing through a hole formed by the piercer;
a piercing condition setting unit for setting a piercing operation condition by the piercer for the specimen vessel having the stopper loaded in the specimen rack based on the rack identification information read by the rack identification information reading unit; and
a controller for controlling the piercing operation of the drive unit based on a piercing operation condition set by the piercing condition setting unit.

2. The automatic analysis apparatus according to claim 1, wherein the piercing operation condition includes at least one of a lower limit of descent, a descent speed, and a piercing force of the piercer, a descent speed pattern of the piercer during descent, inner and outer diameters of the piercer, an upper limit point of the detection area for detecting the liquid level of the specimen with insertion of the suction nozzle into the specimen vessel having the stopper, and a cumulative number of times of piercing.

3. The automatic analysis apparatus according to claim 1, wherein the rack identification information is a coded display printed on or affixed to the specimen rack.

4. The automatic analysis apparatus according to claim 2, wherein the rack identification information is a coded display printed on or affixed to the specimen rack.

5. The automatic analysis apparatus according to claim 1, wherein the rack identification information is formed by a shape peculiar to the specimen rack and/or a physical element for reading the shape.

6. The automatic analysis apparatus according to claim 2, wherein the rack identification information is formed by a shape peculiar to the specimen rack and/or a physical element for reading the shape.

7. The automatic analysis apparatus according to claim 1, wherein the piercing condition setting unit sets a piercing operation condition based on an operation condition table, the rack identification information and a piercing operation condition being associated with each other and stored in the operation condition table.

8. The automatic analysis apparatus according to claim 2, wherein the piercing condition setting unit sets a piercing operation condition based on an operation condition table, the rack identification information and a piercing operation condition being associated with each other and stored in the operation condition table.

9. The automatic analysis apparatus according to claim 3, wherein the piercing condition setting unit sets a piercing operation condition based on an operation condition table, the rack identification information and a piercing operation condition being associated with each other and stored in the operation condition table.

10. The automatic analysis apparatus according to claim 4, wherein the piercing condition setting unit sets a piercing operation condition based on an operation condition table, the rack identification information and a piercing operation condition being associated with each other and stored in the operation condition table.

11. The automatic analysis apparatus according to claim 5, wherein the piercing condition setting unit sets a piercing operation condition based on an operation condition table, the rack identification information and a piercing operation condition being associated with each other and stored in the operation condition table.

12. The automatic analysis apparatus according to claim 6, wherein the piercing condition setting unit sets a piercing operation condition based on an operation condition table, the rack identification information and a piercing operation condition being associated with each other and stored in the operation condition table.

13. A piercing condition selection method for an automatic analysis apparatus including a specimen supply portion, a specimen rack loaded with the same type of one or more specimen vessels having stoppers being arranged in the specimen supply portion, and a drive unit for executing a piercing operation of piercing the stopper of the specimen vessel having the stopper at a specimen suction position by a piercer and sucking a specimen in the specimen vessel having the stopper by a specimen suction nozzle passing through a hole formed by the piercer, and obtaining measurement information on a predetermined test item by causing a reaction between a reagent and the specimen sucked by the specimen suction nozzle to measure a reaction process thereof, the method comprising:
a rack identification information reading step of reading rack identification information assigned to the specimen rack;
a piercing condition setting step of setting a piercing operation condition by the piercer for the specimen vessel having the stopper loaded in the specimen rack based on rack identification information read in the rack identification information reading step; and
an operation control step of controlling the piercing operation of the drive unit based on a piercing operation condition set in the piercing condition setting step.

14. The piercing condition selection method according to claim 13, wherein the piercing operation condition includes at least one of a lower limit of descent, a descent speed, and a piercing force of the piercer, a descent speed pattern of the piercer during descent, inner and outer diameters of the piercer, an upper limit point of the detection area for detecting the liquid level of the specimen with insertion of the suction nozzle into the specimen vessel having the stopper, and a cumulative number of times of piercing.

15. The piercing condition selection method according to claim 13, wherein the rack identification information is a coded display printed on or affixed to the specimen rack.

16. The piercing condition selection method according to claim 14, wherein the rack identification information is a coded display printed on or affixed to the specimen rack.

17. The piercing condition selection method according to claim 13, wherein the rack identification information is formed by a shape peculiar to the specimen rack and/or a physical element for reading the shape.

18. The piercing condition selection method according to claim 14, wherein the rack identification information is formed by a shape peculiar to the specimen rack and/or a physical element for reading the shape.

19. The piercing condition selection method according to claim 13, wherein the piercing condition setting step sets a piercing operation condition based on an operation condition table, the rack identification information and a piercing operation condition being associated with each other and stored in the operation condition table.

20. The piercing condition selection method according to claim 14, wherein the piercing condition setting step sets a piercing operation condition based on an operation condition table, the rack identification information and a piercing operation condition being associated with each other and stored in the operation condition table.

21. The piercing condition selection method according to claim 15, wherein the piercing condition setting step sets a piercing operation condition based on an operation condition table, the rack identification information and a piercing operation condition being associated with each other and stored in the operation condition table.

22. The piercing condition selection method according to claim 16, wherein the piercing condition setting step sets a piercing operation condition based on an operation condition table, the rack identification information and a piercing operation condition being associated with each other and stored in the operation condition table.

23. The piercing condition selection method according to claim 17, wherein the piercing condition setting step sets a piercing operation condition based on an operation condition table, the rack identification information and a piercing operation condition being associated with each other and stored in the operation condition table.

24. The piercing condition selection method according to claim 18, wherein the piercing condition setting step sets a piercing operation condition based on an operation condition table, the rack identification information and a piercing operation condition being associated with each other and stored in the operation condition table.
